(19) United States
(12) Patent Application Publication
(10) Pub. No.: US 2002/0101752 A1
(43) Pub. Date: Aug. 1, 2002

(54) Power delivery apparatus and method

(76) Inventors: Shaun L. Harris, McKinney, TX (US); Eric C. Peterson, McKinney, TX (US)

Correspondence Address: HEWLETT-PACKARD COMPANY, Intellectual Property Administration, P. O. Box 272400, Fort Collins, CO, 80527-2400, US

(21) Appl. No.: 09/774,868

(22) Filed: Jan. 31, 2001

(51) Int. Cl. H02M 1/00

(52) U.S. Cl. 363/144

(57) ABSTRACT

The present invention provides a unitary integrated circuit and power supply module. In one embodiment, this module includes a bridging printed circuit board, an integrated circuit assembly, and a power conversion assembly. The integrated circuit assembly is operably mounted to the bridging printed circuit board. The power conversion assembly is also operably mounted to the bridging printed circuit board. Core power is provided to the integrated circuit assembly through the bridging printed circuit board from the power conversion assembly. In this way, detrimental parasitics are reduced through the elimination of a connector for coupling a power conversion module to an integrated circuit module.

### BACKGROUND

Large power consuming integrated circuit devices, such as processors and various application specific integrated circuit (“ASIC”) devices, are typically mounted on printed circuit boards (“PCB”s) that connect the integrated circuit device to a larger assembly such as a mother board for a computer. The connection is normally made through a PCB connector such as a cinching pin grid array (“PGA”) or land grid array (“LGA”) connection to the larger assembly. Not only signal lines (e.g., address, data, and control signals), but also core power lines for powering the integrated circuit device, are provided through this PCB connector. This arrangement requires the signal and power line connections as well as the traces to compete for optimum PCB space. This results in each function being compromised. Compromised power line distribution results in increased resistive and inductive parasitics, which lead to unacceptable heat losses and di/dt voltage fluctuations. To redress such problems, Intel™, for example, introduced an integrated circuit (processor) package that allows the core power to be delivered through the side of the integrated circuit device via an edge-card connection rather than through the PCB surface mount connector. A power conversion module is then used to deliver the high-current power to the integrated circuit device through the edge-card connection. The power conversion module serves as a DC to DC down converter for receiving from the mother board and down-converting a relatively high voltage (e.g., 48 VDC), low current source and providing to the integrated circuit device a low voltage (e.g., 1.3 VDC), high current power supply.

FIGS. 1A and 1B show top and bottom views, respectively, of a conventional power conversion module 100 for providing power to an integrated circuit device module as described above (not shown). Power conversion module 100 includes power module assembly 120, edge card connector 115, and source connector 125. The edge-card connector 115 provides the down converted power to the integrated circuit device. The source connector 125 mates with a second cooperating connector for receiving the relatively high voltage source from the motherboard. Normally, this cooperating second connector (not shown) is mounted through a “pig-tail ” or “flying cable ” connection to the mother board power source. A flying cable or pig-tail connection allows module 100 to be moved when operably mounted to the mother board. When the integrated circuit module's PCB connector is a cinching type grid array connector, this is important because the integrated circuit module will shift when being “cinched ” to or released from the cinch connector.

Unfortunately, the power delivery solution of FIGS. 1A and 1B have several associated problems. To begin with, “pig tail ” or “flying cable ” couplings are difficult to assemble and to access after assembly. In addition, it has been observed that even with separate connections (e.g., edge card connection) for receiving core power, integrated circuit devices continue to exhibit excessive resistive and inductive parasitics, which as already mentioned, induce heat losses and unacceptable supply voltage noise.

FIG. 2 is a schematic diagram showing the load characteristics of a microprocessor integrated circuit device with a conventional edge card connection for providing core power therein. As seen in this drawing, edge card connector P1 imposes an added load resistance R1 of 0.9 m′Ω (milli-ohm) and an added load inductance L1 of 400 pH onto the power conversion module 100. While these load parasitics may seem trivial, it has been observed that they significantly impair the ability of the integrated circuit module to operate at a high performance level (e.g., at high operating frequencies). Voltage noise attributable to this input inductance is roughly the input inductance, L1, times the change in current as a fraction of time, di/dt. With conventional high-performance processors, input power current changes of up to 100 A per micro-second can be expected. Thus, with an input inductance, L1, of 400 pH, voltage noise of up to 40 mV would be imposed at the processor's power input. This is extremely problematic since a frequency performance degradation of 100 MHz. occurs for every 10 mV of input noise. A processor with a power input connector of FIGS. 1A and 1B, at best, could only be operated at 400 MHz. below its designed operational frequency.

Accordingly, a need exists for an improved power delivery solution for an integrated circuit device.

### SUMMARY OF THE INVENTION

These and other objects, features and technical advantages are achieved by a power conversion system of the present invention. In one embodiment, a power conversion module is provided for supplying core power to an integrated circuit module that has a first connector for receiving the core power. The module generally includes a power conversion assembly, one or more surface mountable source connectors, and an output connector. The power conversion assembly has a power converter unit and a power output section. The power converter unit has an input for receiving input source power and an output coupled to the power output section for providing it with supply power converted from the input source power. The one or more surface mountable source connectors are mounted to the power conversion assembly and are operably connected to the power converter unit for providing it with the input source power. In addition, the one or more source connectors are adapted to cooperatively connect to pads of a system assembly (such as a mother board assembly) for receiving the input source power. Finally, the output connector is mounted to the power conversion assembly and is operably connected to the power output section for receiving the converted supply power therefrom. In addition, the output connector is adapted to cooperatively connect to the first connector of the integrated circuit module for providing it with core power from the converted supply power.

The present invention also provides a unitary integrated circuit and power supply module. In one embodiment, this module includes a bridging printed circuit board, an integrated circuit assembly, and a power conversion assembly. The integrated circuit assembly is operably mounted to the bridging printed circuit board. The power conversion assembly is also operably mounted to the bridging printed circuit board. Core power is provided to the integrated circuit assembly through the bridging printed circuit board from the power conversion assembly. In this way, detrimental parasitics are reduced through the elimination of a connector for coupling a power conversion module to an integrated circuit module.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, reference is now made to the following descriptions taken in conjunction with the accompanying drawing, in which:

FIG. 1A is a top view of a conventional power conversion module;

FIG. 1B is a bottom view of the conventional power conversion module of FIG. 1A;

FIG. 2 is a schematic diagram showing the load characteristics of a microprocessor integrated circuit device with a conventional edge card connection for providing core power therein;

FIG. 3A is a top view of a power conversion module of the present invention;

FIG. 3B is a bottom view of the power conversion module of FIG. 3A;

FIG. 4 is a block drawing of the power conversion module of FIGS. 3A and 3B;

FIG. 5 is a perspective view of a power conversion and integrated circuit module of the present invention;

FIG. 6 is a block drawing of the power conversion and integrated circuit module of FIG. 5; and

FIG. 7 is a schematic diagram showing the load characteristics of the integrated circuit device of the power conversion and integrated circuit module of FIGS. 5 and 6.

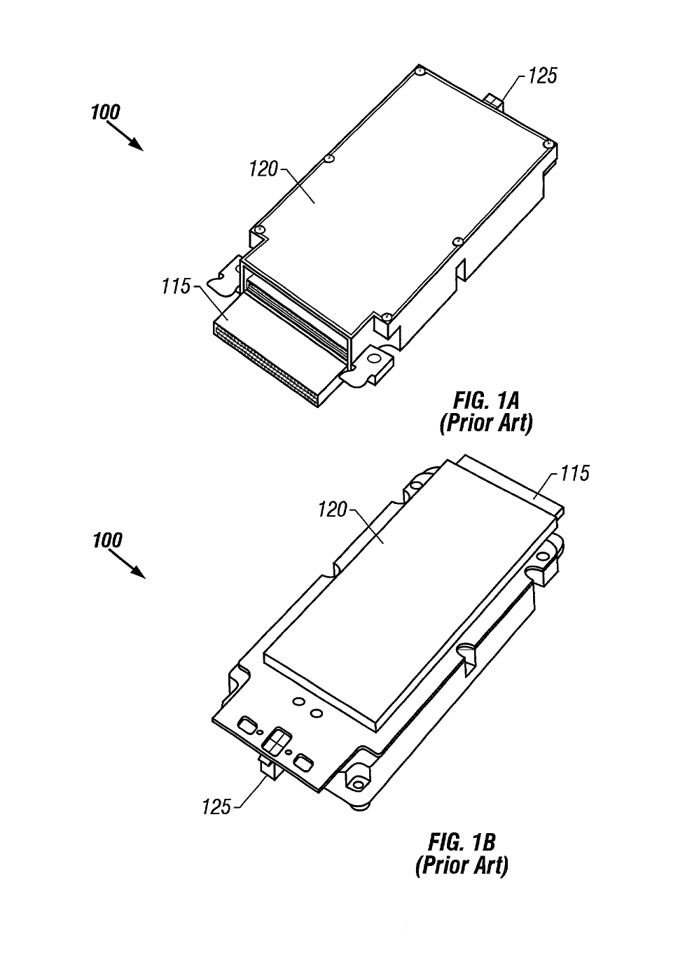

### DETAILED DESCRIPTION

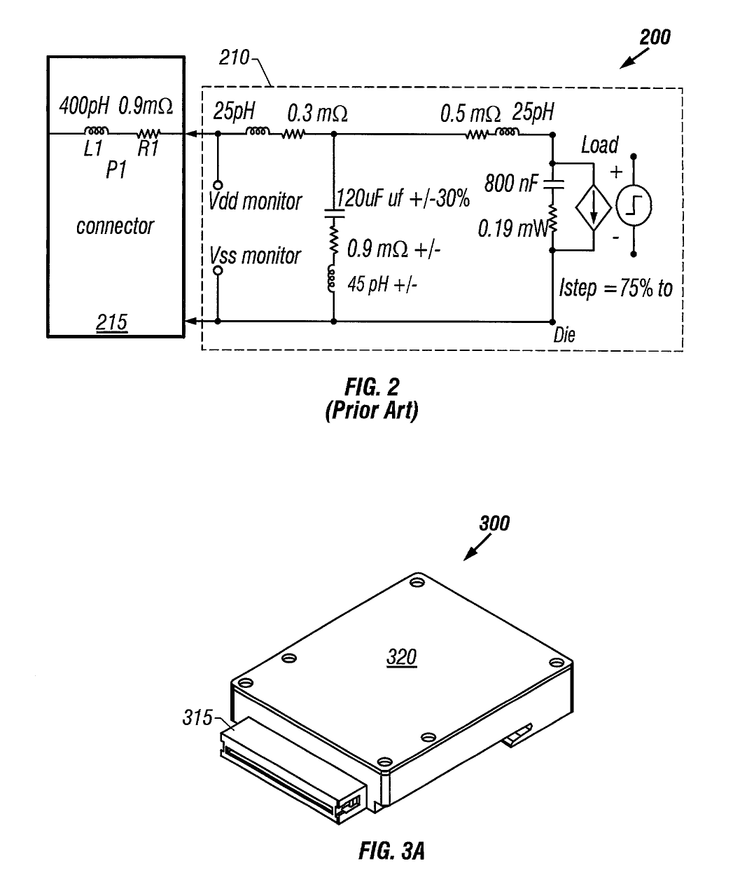

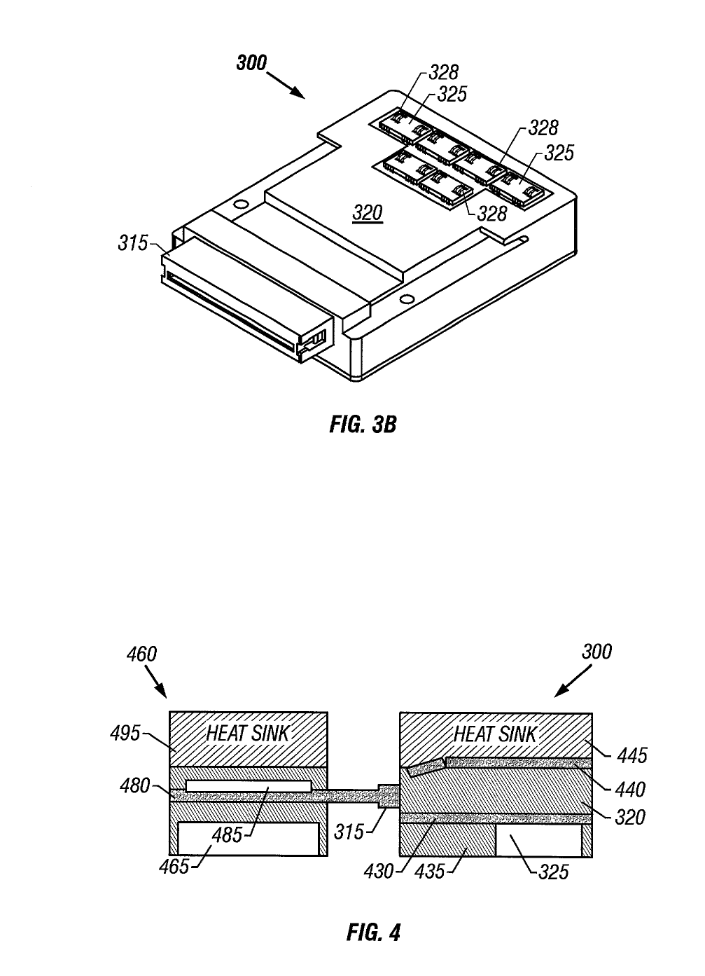

FIGS. 3A and 3B show top and bottom views, respectively, of one embodiment of a power conversion module 300 of the present invention. Power conversion module 300 generally includes power converter assembly 320, edge connector 315, and (as shown in FIG. 3B) surface-mountable source connectors 325, which advantageously have spring contacts 328. Power converter assembly 320 comprises a power supply (or power conversion unit) for supplying power to an integrated circuit module (not shown).

In one embodiment, power converter assembly 320 comprises a DC to DC down converting power supply for receiving and down converting a relatively high source voltage and providing to the integrated circuit module a relatively low-voltage (high current) supply. This high current supply is delivered to the integrated circuit module through edge connector 315. Edge connector 315 couples this high-current supply to the integrated circuit module through a corresponding connector of the integrated circuit module. Edge connector 315 includes several conductors for supplying power to the integrated circuit module. In one embodiment, these conductors include high current capacity supply and return bars, along with one or more control lines such as voltage sense and switching lines.

Instead of providing the source power to the power converter module through a pig tail (or similar) connection, one or more surface mountable source connectors 325 are used to provide power to module 300 directly from connection pads of a system assembly (e.g., a computer mother board). Thus, surface mountable source connector(s) 325 are operably mounted to the underside of power converter assembly 320. This allows power converter module 300 to be more efficiently mounted into the mother board. It also allows power converter module 300 to move when mated to an integrated circuit module that is being “cinched ” into or released from its grid array connection. Furthermore, it eliminates the need for a corresponding, cooperative connector mounted to the mother board. That is, surface mountable connectors 325 “connect ” directly to pads on the mother board PCB. In the depicted embodiment, six connectors 325—each having 4 contacts—are used to provide 28 surface mount contacts 328. However, depending on factors (e.g., voltage, current, control signal requirements) relating to the supplied power source from the larger assembly, any suitable configuration could be used in this power converter module implementation.

FIG. 4 shows a quasi block drawing of power conversion module 300 coupled to an integrated circuit module 460 through edge connector 315. Along with power converter assembly 320, edge connector 315 and source connector 325, heat sink 445, which is operably mounted to power converter assembly 320, is also shown as part of the power converter module 300.

Additionally seen in this drawing, power converter assembly 320 includes power converter card 430, power converter unit 435 mounted thereupon, and power output card 440. Power converter unit (e.g., DC to DC down-converter) 435 appropriately converts the source power into the required supply power for powering integrated circuit module 460. Power converter unit 435 receives the input source voltage through power converter card 430, which is connected to source connector 325. Power converter unit 435 is also connected to power output card 440 for providing it with the converted supply power. In turn, power output card 440 is connected to edge connector 315 for coupling the supply power to integrated circuit module 460.

As shown in FIG. 4, integrated circuit module 460 generally includes integrated circuit signal connector 465, integrated circuit PCB 480, integrated circuit die 485, and heat sink 495. Integrated circuit die 485 is operably mounted to integrated circuit PCB (or daughter card) 480. Integrated circuit signal connector 465 is also mounted to integrated circuit PCB 480 for providing integrated circuit die 485 with signal lines (and possibly relatively small power sources) from a mother board (not shown). Integrated circuit PCB 480 also has an appropriate edge card connection (hidden from view) for mating with edge connector 315 in order to receive core supply power from the power conversion module 300. Finally, heat sink 495 is operably mounted to integrated circuit module 460 for conducting heat away from integrated circuit die 485.

Source power is coupled to power conversion module 300 through surface mountable source connector 325. This is a substantial improvement over conventional pigtail or flying cable connections and allows power conversion module 300 to be more conveniently and efficiently mounted onto a mother board. In addition, it provides a “cleaner ” connection for providing source power from the mother board to power conversion module 300.

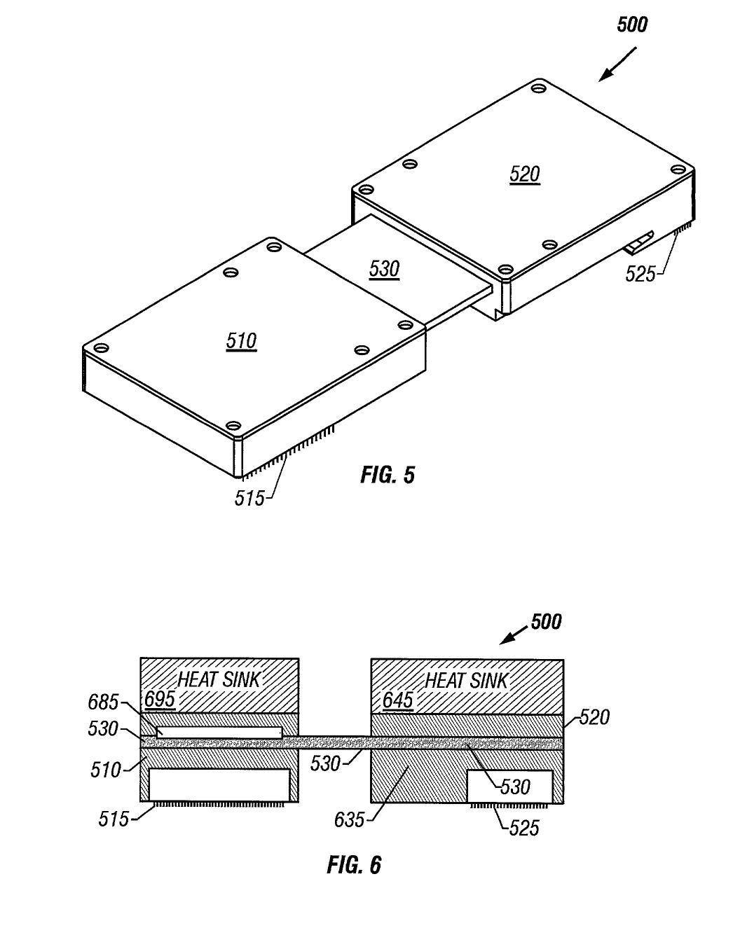

FIG. 5 shows one embodiment of an integrated circuit and power module 500 of the present invention. This module generally includes an integrated circuit assembly 510 with an associated integrated circuit signal connector 515, a power conversion assembly 520 with an associated source connector 525, and a bridging PCB 530. Integrated circuit module portion 510 is mounted at one end of bridging PCB 530; while power conversion module portion 520 is mounted at its other end. In essence, bridging PCB 530 is used for transferring power from power conversion assembly 520 to integrated circuit assembly 510. This eliminates the edge card connectors, which were previously used for coupling the power conversion module to the integrated circuit module. In this way, parasitic load resistance and inductance are significantly reduced for optimizing the power coupling to the integrated circuit assembly.

Power conversion assembly 520 includes source connector 525 which, in the depicted embodiment, comprises a surface mountable PGA connector. Source connector 525 is utilized to couple source power from the mother board (not shown) to power conversion assembly 520. Likewise, integrated circuit assembly includes integrated circuit signal connector 515, which in the depicted embodiment is also a surface mountable PGA connector. Connector 515 is used to couple signal connections (and possibly small power source connections) to integrated circuit assembly 510 from the mother board (or other system assembly).

In the depicted embodiment, bridging PCB 530 comprises a conventional multilayered (e.g., 17 layers) printed circuit board. Two of these layers are supply planes; two layers are used as return planes; and the remaining 13 layers are used as signal and impedance control planes. Most of the significant portions of the signal and impedance control layers will normally be associated with the integrated circuit and power conversion assemblies, 510 and 520, respectively. That is, the exposed portion of bridging PCB 530 in the depicted drawing substantially corresponds to the supply and return planes of bridging PCB 530.

FIG. 6, in a quasi-block diagram form, depicts integrated circuit and power conversion module 500 from FIG. 5. As seen in FIG. 6, power conversion assembly 520 includes power converter unit 635 mounted to bridging PCB 530. It also includes an operably mounted heat sink 645. Integrated circuit assembly 510 includes an integrated circuit die 685, which is also mounted to bridging PCB 530. Integrated circuit assembly 510 also includes its own operably mounted heat sink 695. Single bridging PCB 530 is utilized for not only coupling power from power conversion assembly 520 to integrated circuit assembly 510, but also, for separately interconnecting the various signals associated with each of these assemblies. Thus, bridging PCB 530 serves two fundamental roles. It provides PCB functionality for each of the integrated circuit and power conversion assemblies, and it provides a highly efficient power coupling from the power conversion assembly to the integrated circuit assembly. In the depicted embodiment, both the power conversion unit and power output functions are subsumed within power conversion unit 635 and mounted to bridging PCB 530. However, a separate card(s) could be used for different parts of power conversion unit 635 so long as the power output section is mounted to bridging PCB 530.

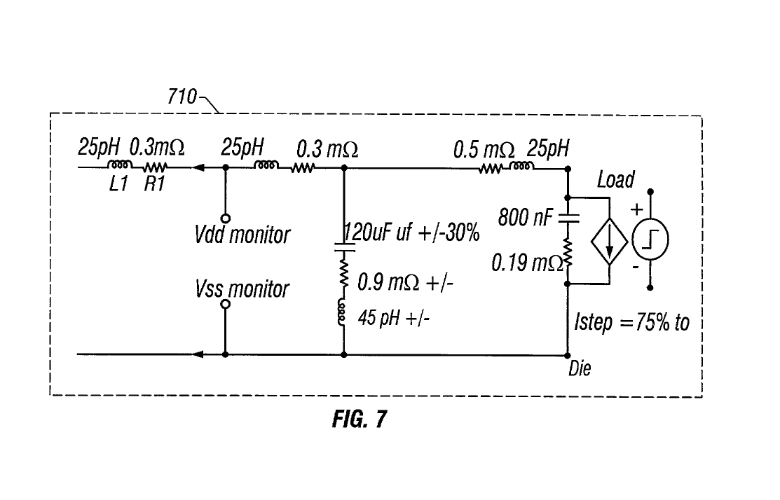

With reference to FIG. 7, the improved load characteristics of the integrated circuit assembly may be observed. As seen in this schematic, input inductance 11 has been reduced to 25 pH, and the input resistance R1 has been reduced to 0.3 m′Ω. This corresponds to an order of magnitude reduction in input parasitic impedance. With the input inductance being reduced to 25 pH, expected worse-case current fluctuations of 100 A per msec. will induce only 2.5 mV of noise a the integrated circuit assembly's input. This imposes an acceptably low frequency performance degradation of only 25 MHz.

It should be recognized that while the integrated circuit and power conversion module in the depicted embodiment is implemented as two, discrete modules mounted to a common bridging PCB 530 persons of skill will recognize that numerous suitable alternatives may also be implemented. For example, the integrated circuit and power conversion portions could be mounted into a signal module for enhancing structural and heat transfer characteristics. In addition, in the depicted embodiment, a relatively long bridging PCB 530 is shown. As much as anything, this more readily conveys the general concept of using a PCB for coupling the modules. However, designers may wish to decrease the distance between the power conversion and integrated circuit portions in order to optimally reduce the coupling impedance parasitics. Specific optimal geometries and board layouts will depend upon the particular operational and design parameters of the associated integrated circuit and power conversion portions. Moreover, separate connectors have been used in the depicted embodiment for the integrated circuit and power conversion assemblies. However, single or multiple connectors could be used depending on specific design considerations. Along these lines, any suitable connector type could be used for supplying signals and source power to the integrated circuit and power conversion assemblies, respectively.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A power conversion module for supplying power to an integrated circuit module having a first connector for receiving said power, comprising:
a power conversion assembly having a power converter unit and a power output section, wherein the power converter unit has an input for receiving input source power and an output coupled to the power output section for providing said output section with supply power converted from the input source power;
one or more surface mountable source connectors mounted to the power conversion assembly and operably connected to the power converter unit for providing it with the input source power, wherein the one or more source connectors are adapted to cooperatively connect to pads of a system assembly for receiving the input source power; and
an output connector mounted to the power conversion assembly and operably connected to the power output section for receiving the converted supply power, wherein the output connector is adapted to cooperatively connect to the first connector of the integrated circuit module for providing said module with power from the converted supply power.

2. The power conversion module of claim 1 wherein the power converter unit is DC to DC down converter for converting the source power from a relatively high voltage, low current DC power to a relatively low voltage, high current power.

3. The power conversion module of claim 1 wherein the integrated circuit module comprises a microprocessor.

4. The power conversion module of claim 3 wherein the system assembly corresponds to a computer mother board.

5. An integrated circuit and power conversion module, comprising:
a bridging printed circuit board;
an integrated circuit assembly operably mounted to the bridging printed circuit board; and
a power conversion assembly operably mounted to the bridging printed circuit board,
wherein the power conversion assembly provides core power to the integrated circuit assembly through the printed bridging circuit board.

6. The module of claim 5 wherein the printed circuit board comprises a multi-layered circuit board with one or more supply and return planes for coupling the integrated circuit assembly with power from the power conversion assembly.

7. The module of claim 5 further comprising one or more surface mountable source connectors mounted to the power conversion assembly for coupling source power from a system assembly to the power conversion assembly.

8. The module of claim 7 wherein the system assembly corresponds to a motherboard assembly.

9. The module of claim 5 wherein the integrated circuit assembly and power conversion assemblies are mounted within a common module.

10. The module of claim 5 wherein the power conversion assembly includes a power converter unit for down converting a relatively high voltage, small current input source power to a relatively low voltage, high current output supply power.

11. The module of claim 10 wherein the power converter unit is mounted to the bridging printed circuit board and comprises a power output section operably connected to supply and return planes within the bridging printed circuit board for providing the integrated circuit assembly with the output supply power.

12. The module of claim 10 wherein the power converter unit is mounted to a separate printed circuit board within the power conversion assembly, the power converter unit being operably connected to a power output section that is mounted to the bridging printed circuit board for providing the integrated circuit assembly with the output supply power.

13. The module of claim 5 further comprising a grid array connector mounted to the bridging printed circuit board for cooperatively connecting the integrated circuit assembly with a mother board.

14. The module of claim 5 further comprising a grid array connector mounted to the bridging printed circuit board for cooperatively connecting both the integrated circuit and power conversion assemblies to a mother board.

15. An integrated circuit and power conversion module, comprising:
a bridging printed circuit board having one or more supply and return layers;
a power conversion assembly having supply and return outputs connected to the supply and return layers for providing said layers with an output supply power; and
an integrated circuit assembly having supply and return inputs connected to the supply and return layers for receiving the output supply power to provide core power to an integrated circuit within the integrated circuit assembly.

16. The module of claim 15 wherein the power conversion assembly has an input for receiving a relatively high voltage, low current power source that is converted by the power conversion assembly into the output power supply, which is a relatively low voltage, high current power supply.

17. The module of claim 16 further comprising a surface mountable source connector operably mounted to the bridging printed circuit board for providing the power conversion assembly with the input power source.

18. The module of claim 17 wherein the bridging printed circuit board has one or more source and return layers for coupling the input source power from the surface mountable source connector to the power conversion assembly.

19. The module of claim 16 further comprising a surface mountable source connector operably mounted to a separate printed circuit board for providing the power conversion assembly with the input power source.

20. The module of claim 15 wherein the integrated circuit assembly comprises a microprocessor integrated circuit die that consumes more than 100 amps of core current.
